(19) United States
(12) Patent Application Publication
(10) Pub. No.: US 2026/0027523 A1
(43) Pub. Date: Jan. 29, 2026

(54) LOW PRESSURE MEMBRANE VESSEL

(71) Applicant: RELCO LLC, Willmar, MN (US)

(72) Inventors: Chris Gault, Marshfield, WI (US); John Edward Zirbel, Stratford, WI (US)

(21) Appl. No.: 19/179,492

(22) Filed: Apr. 15, 2025

Related U.S. Application Data
(60) Provisional application No. 63/634,401, filed on Apr. 15, 2024.

(51) Int. Cl. B01D 63/00

(52) U.S. Cl. CPC B01D 63/00; B01D 2313/02; B01D 2313/041; B01D 2313/2011; B01D 2313/205; B01D 2313/2062; B01D 2313/21

(57) ABSTRACT

The present disclosure is directed to a membrane vessel, the membrane vessel comprising: a cylindrical tube for holding a membrane element, the cylindrical tube having a first end and a second end; at least one flared end of the cylindrical tube wherein the tube flares outward at an angle from the end of the cylindrical tube; a cap configured to fit into the end of the cylindrical tube, the cap comprising an inclined distal perimeter surface configured to contact the inner surface of the flared tube.

This application claims the benefit of U.S. Provisional Application No. 63/634,401, filed Apr. 15, 2024, the contents of which are herein incorporated by reference.

### FIELD

Embodiments herein relate to a membrane vessel, in particular a low-pressure membrane vessel.

### SUMMARY

The present disclosure is directed, in an embodiment, to a membrane vessel, the membrane vessel comprising a) a cylindrical tube for holding a membrane element, the cylindrical tube having a first end and a second end; b) at least one flared end of the cylindrical tube wherein the tube flares outward at an angle from the end of the cylindrical tube; and c) a cap configured to fit into the end of the cylindrical tube, the cap comprising an inclined distal perimeter surface configured to contact the inner surface of the flared end of the tube.

In an embodiment, the cylindrical tube comprises stainless steel.

In an embodiment, the flared end of the cylindrical tube is integrally formed with the tube body.

In an embodiment, the flared end has an angle of approximately 110 degrees from the outside surface of the flaring to the outer surface of the non-flared portion of the cylindrical tube.

In an embodiment, the flared end has an angle of 108 to 112 degrees from the outside surface of the flaring to the outer surface of the non-flared portion of the cylindrical tube.

In an embodiment, the flared end has an angle of 105 to 115 degrees from the outside surface of the flaring to the outer surface of the non-flared portion of the cylindrical tube.

In an embodiment, the flared end has an angle of 100 to 120 degrees from the outside surface of the flaring to the outer surface of the non-flared portion of the cylindrical tube.

In an embodiment, the flared end has an angle of 95 to 125 degrees from the outside surface of the flaring to the outer surface of the non-flared portion of the cylindrical tube.

In an embodiment, the flared end has an angle of greater than 95 degrees from the outside surface of the flaring to the outer surface of the non-flared portion of the cylindrical tube.

In an embodiment, the flared end has an angle of greater than 100 degrees from the outside surface of the flaring to the outer surface of the non-flared portion of the cylindrical tube.

In an embodiment, the flared end has an angle of greater than 105 degrees from the outside surface of the flaring to the outer surface of the non-flared portion of the cylindrical tube.

In an embodiment, the flared end has an angle of greater than 110 degrees from the outside surface of the flaring to the outer surface of the non-flared portion of the cylindrical tube.

In an embodiment, the flared end has an angle of greater than 115 degrees from the outside surface of the flaring to the outer surface of the non-flared portion of the cylindrical tube.

In an embodiment, the distal perimeter surface of the cap has a surface with an angle corresponding to the angle of the flared end of the cylinder.

In an embodiment, the cap comprises a proximal perimeter surface.

In an embodiment, the cap comprises a proximal permitter surface having an angle mirroring a distal perimeter surface.

In an embodiment, the membrane vessel comprises a clamp for securing the cap to the flared end of the cylindrical housing.

In an embodiment, the membrane vessel comprises a clamp for securing the cap to the flared end of the cylindrical housing, the clamp configured to engage a proximal perimeter surface of the cap and an outer surface of the flared end of the cylinder, and apply pressure to retain the cap on the flared end of the cylinder.

In an embodiment, the vessel and cap further comprises an o-ring.

In an embodiment, the o-ring is positioned distal to the opening on the cylindrical tube.

In an embodiment, the o-ring is positioned at the interior of the cylindrical tubing where it begins to flare out.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is partial side cross-sectional view of the end of a membrane vessel and cap in accordance with various embodiments herein.

FIG. 2 side cross-sectional view of the end of a membrane vessel and cap in accordance with various embodiments herein.

FIG. 3 is a truncated side view of a membrane vessel in accordance with various embodiments herein.

FIG. 4 is cross-sectional view of a membrane vessel in accordance with various implementations herein.

FIG. 5 is cross-sectional view of the end of a membrane vessel in accordance with various implementations herein.

FIG. 6 is an end view of an end cap of membrane vessel in accordance with various embodiments herein.

FIG. 7 is a cross-sectional view of an end cap of membrane vessel in accordance with various embodiments herein.

FIG. 8 is an enlarged cross-sectional end view of the fluted end of a membrane vessel in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

The present disclosure is directed to a membrane vessel, the membrane vessel comprising: a cylindrical tube for holding a membrane element, the cylindrical tube having a first end and a second end; at least one flared end of the cylindrical tube wherein the tube flares outward at an angle from the end of the cylindrical tube; a cap configured to fit into the end of the cylindrical tube, the cap comprising an inclined distal perimeter surface configured to contact the inner surface of the tube flaring.

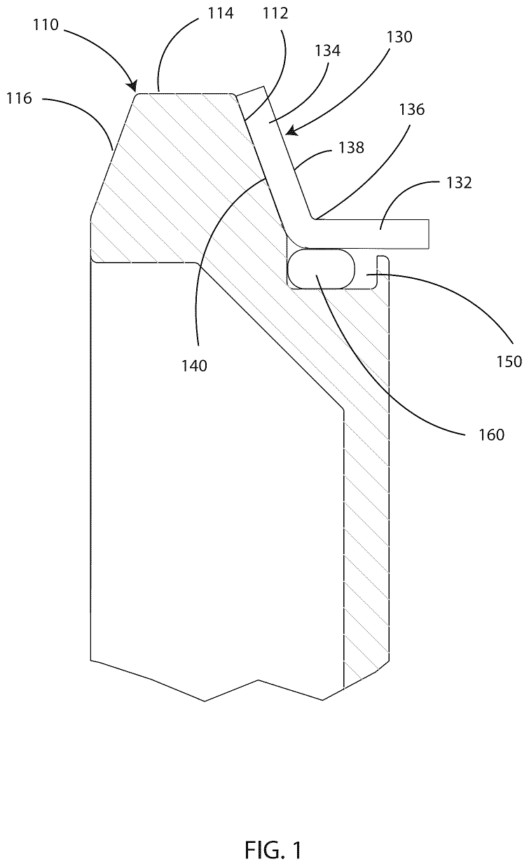

Referring now to drawings, FIG. 1 is partial side cross-sectional view of the end of a membrane vessel 130 and cap 110 in accordance with various embodiments herein, showing the membrane vessel 130 having non-flared body 132 with a flared end 134. The flared end 134 of the membrane vessel 130 includes an outer surface 138 and an inner surface 140.

The cap 110 includes an inclined distal perimeter surface 112, and an inclined proximal perimeter portion 116 (with proximal referring to the outer end of the cap 110, which is on the left in FIG. 1; and distal referring to the inner end of the cap 110, which on the right in FIG. 1). In intermediate perimeter portion 114 of the cap 110 is also shown. FIG. 1 further shows an o-ring 160 in a groove 150 in the cap 110. The o-ring 160 provides a seal between the cap 110 and the interior wall of the membrane vessel 130. Not shown on FIG. 1, but discussed below, is a clamp for securing the cap 110 to the membrane vessel 130 at the flared end 134.

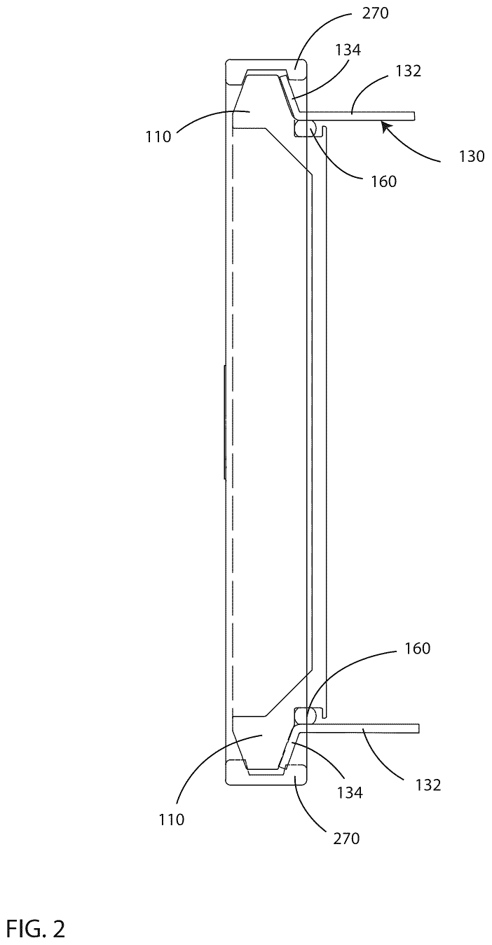

FIG. 2 side cross-sectional view of the end of a membrane vessel 130 and cap 110 in accordance with various embodiments herein, showing how the elements fit together, including the cap 110, flared end 134 to membrane vessel 130, plus an o-ring 160 and clamp 270.

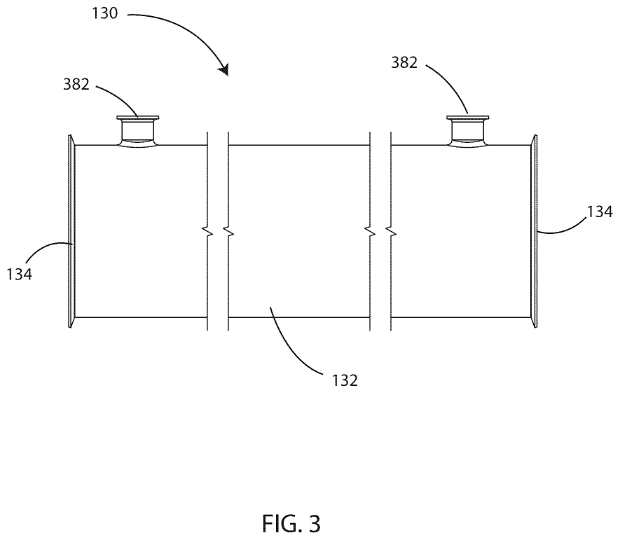

FIG. 3 is truncated side view of a membrane vessel 130 in accordance with various embodiments herein, including side ferrules 382 or ports for fluid connections into the membrane vessel 130. FIG. 3 shows the flared ends 134 that are integrally formed from the membrane vessel 130 (as opposed to being welded onto the membrane vessel 130. In a typical embodiment the membrane vessel 130 will have an approximate diameter of 8 inches.

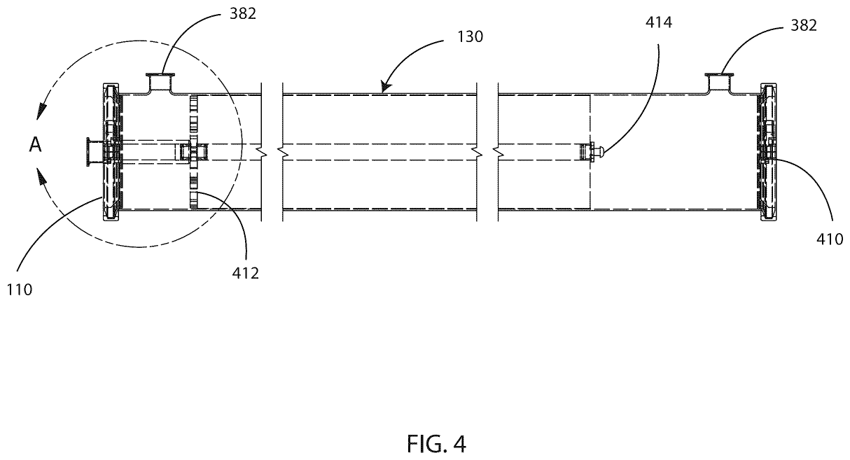

FIG. 4 is cross-sectional view of a membrane vessel 130 in accordance with various implementations herein, showing additional features, such as an anti-telescoping device 412 (ATD), and anti-telescoping device end plug 414.

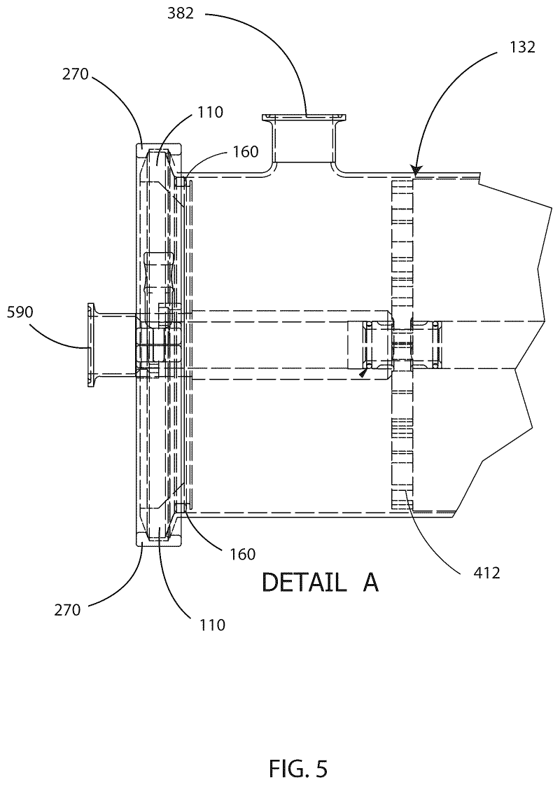

FIG. 5 is cross-sectional view of the end of a membrane vessel in accordance with various implementations herein, showing cap 110, o-ring 160, side ports or ferrules 382, clamp 270, anti-telescoping device 412, and end cap ferrule 590.

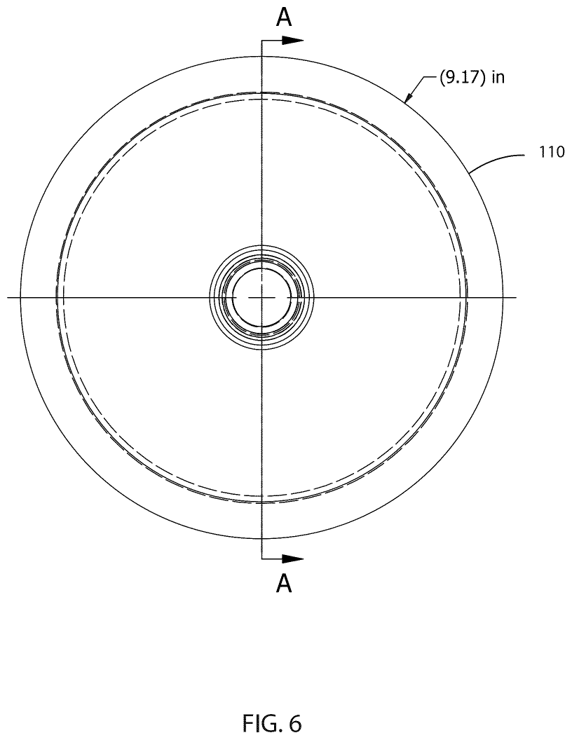

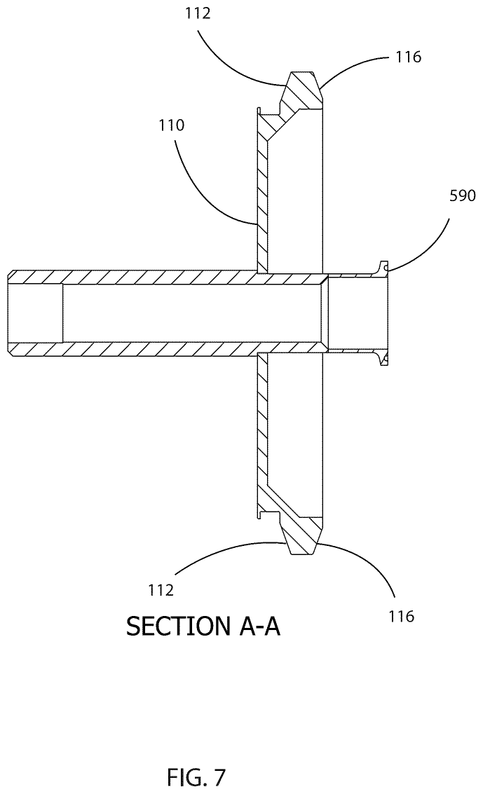

FIG. 6 is an end view of an end cap 110 of membrane vessel in accordance with various embodiments herein. FIG. 7 is a cross-sectional view of an end cap of membrane vessel in accordance with various embodiments herein, taken along section A-A of FIG. 6; showing the end cap 110 with perimeter surfaces 112 and 116; along with end cap ferrule 590.

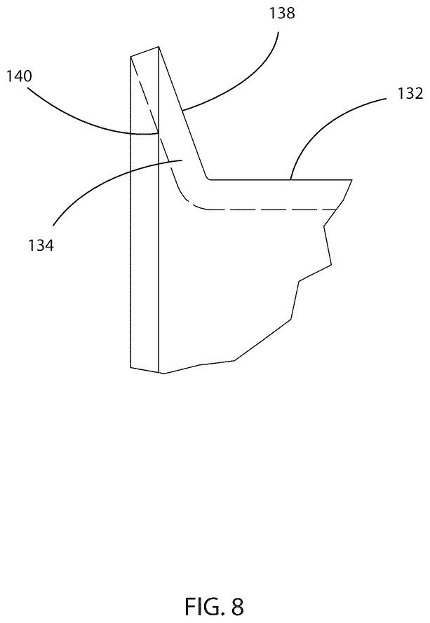

FIG. 8 is an enlarged cross-sectional end view of the flared end 134 of a membrane vessel 130 in accordance with various embodiments herein. Membrane vessel 130 having non-flared body 132 with a flared end 134. The flared end 134 of the membrane vessel 130 includes an outer surface 138 and an inner surface 140.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A membrane vessel, the membrane vessel comprising:
a) a cylindrical tube for holding a membrane element, the cylindrical tube having a first end and a second end;
b) at least one flared end of the cylindrical tube wherein the tube flares outward at an angle from the end of the cylindrical tube; and
c) a cap configured to fit into the end of the cylindrical tube, the cap comprising an inclined distal perimeter surface configured to contact the inner surface of the flared end.

2. The membrane vessel of claim 1, wherein the cylindrical tube comprises stainless steel.

3. The membrane vessel of claim 1, wherein the flared end of the cylindrical tube is integrally formed with the tube body.

4. The membrane vessel of claim 1, wherein the flared end has an angle of approximately 110 degrees from the outside surface of the flaring to the outer surface of the non-flared portion of the cylindrical tube.

5. The membrane vessel of claim 1, wherein the flared end has an angle of 108 to 112 degrees from the outside surface of the flaring to the outer surface of the non-flared portion of the cylindrical tube.

6. The membrane vessel of claim 1, wherein the flared end has an angle of 105 to 115 degrees from the outside surface of the flaring to the outer surface of the non-flared portion of the cylindrical tube.

7. The membrane vessel of claim 1, wherein the flared end has an angle of 100 to 120 degrees from the outside surface of the flaring to the outer surface of the non-flared portion of the cylindrical tube.

8. The membrane vessel of claim 1, wherein the flared end has an angle of 95 to 125 degrees from the outside surface of the flaring to the outer surface of the non-flared portion of the cylindrical tube.

9. The membrane vessel of claim 1, wherein the flared end has an angle of greater than 95 degrees from the outside surface of the flaring to the outer surface of the non-flared portion of the cylindrical tube.

10. The membrane vessel of claim 1, wherein the flared end has an angle of greater than 100 degrees from the outside surface of the flaring to the outer surface of the non-flared portion of the cylindrical tube.

11. The membrane vessel of claim 1, wherein the flared end has an angle of greater than 105 degrees from the outside surface of the flaring to the outer surface of the non-flared portion of the cylindrical tube.

12. The membrane vessel of claim 1, wherein the flared end has an angle of greater than 110 degrees from the outside surface of the flaring to the outer surface of the non-flared portion of the cylindrical tube.

13. The membrane vessel of claim 1, wherein the flared end has an angle of greater than 115 degrees from the outside surface of the flaring to the outer surface of the non-flared portion of the cylindrical tube.

14. The membrane vessel of claim 1, wherein the distal perimeter surface of the cap has a surface with an angle corresponding to the angle of the flared end of the cylinder.

15. The membrane vessel of claim 1, wherein the cap comprises a proximal perimeter surface.

16. The membrane vessel of claim 1, wherein the cap comprises a proximal permitter surface having an angle mirroring a distal perimeter surface.

17. The membrane vessel of claim 1, further comprising a clamp for securing the cap to the flared end of the cylindrical housing.

18. The membrane vessel of claim 1, further comprising a clamp for securing the cap to the flared end of the cylindrical housing, the clamp configured to engage a proximal perimeter surface of the cap and an outer surface of the flared end of the cylinder, and apply pressure to retain the cap on the flared end of the cylinder.

19. The membrane vessel of claim 1, further comprising an o-ring; wherein the o-ring is positioned at the interior of the cylindrical tubing where it begins to flare out.

20. The membrane vessel of claim 21, wherein the o-ring is positioned distal to the opening on the cylindrical tube.

21. (canceled)
